(19) United States
(12) Patent Application Publication
(10) Pub. No.: US 2025/0301530 A1
(43) Pub. Date: Sep. 25, 2025

(54) METHOD AND DEVICE FOR REPORTING IDC PROBLEM IN MOBILE COMMUNICATION SYSTEM

(71) Applicant: Samsung Electronics Co., Ltd., Suwon-si, Gyeonggi-do (KR)

(72) Inventors: Sangbum KIM, Suwon-si (KR); Anil AGIWAL, Suwon-si (KR)

(21) Appl. No.: 18/861,439

(22) PCT Filed: Apr. 20, 2023
(86) PCT No.: PCT/KR2023/005361

§ 371 Date: Oct. 29, 2024

(30) Foreign Application Priority Data
Apr. 29, 2022 (KR) 10-2022-0053570

(51) Int. Cl. H04W 76/28; H04W 72/0446; H04W 72/0453

(52) U.S. Cl. CPC H04W 76/28; H04W 72/0446; H04W 72/0453

(57) ABSTRACT

The present disclosure relates to a 5G or 6G communication system for supporting higher data transmission rates. According to an embodiment of the present disclosure, proposed are a method for reporting an IDC problem between 3GPP and non-3GPP systems in an MR-DC scenario, a method for reporting an IDC problem in BWP or PRB units in more detail compared to existing methods, a method for reporting a TDM-based solution preferred by a terminal, a method for introducing an autonomous denial function for NR, and a method for improving SON/MDT considering IDC problems. According to various embodiments of the present disclosure, provided are a method for reporting IDC-related information and a preferred solution, and a device capable of performing same. Accordingly, an effect of improving a method for reporting IDC-related information and a preferred solution may be obtained.

### TECHNICAL FIELD

The disclosure relates to operations of a terminal and base station in a mobile communication system. More particularly, the disclosure relates to a method for reporting an in-device coexistence (IDC) problem in a communication system and a device capable of executing the method.

### BACKGROUND ART

5G mobile communication technology defines a wide frequency band to enable fast transmission speed and new services, and can be implemented not only in a sub-6 GHz frequency band (“sub 6 GHz”) such as 3.5 GHz but also in an ultra-high frequency band (“above 6 GHz”) called mmWave such as 28 GHz or 39 GHz. In addition, 6G mobile communication technology called “beyond 5G system” is being considered for implementation in a terahertz (THz) band (e.g., band of 95 GHz to 3 THz) to achieve transmission speed that is 50 times faster and ultra-low latency that is reduced to 1/10 compared with 5G mobile communication technology.

In the early days of 5G mobile communication technology, to meet service support and performance requirements for enhanced mobile broadband (eMBB), ultra-reliable and low-latency communication (URLLC), and massive machine-type communications (mMTC), standardization has been carried out regarding beamforming for mitigating the pathloss of radio waves and increasing the propagation distance thereof in the mmWave band, massive MIMO, support of various numerology for efficient use of ultra-high frequency resources (e.g., operating multiple subcarrier spacings), dynamic operations on slot formats, initial access schemes to support multi-beam transmission and broadband, definition and operation of bandwidth parts (BWP), new channel coding schemes such as low density parity check (LDPC) codes for large-capacity data transmission and polar codes for reliable transmission of control information, L2 pre-processing, and network slicing for providing a dedicated network specialized for a specific service.

Currently, discussions are underway to improve 5G mobile communication technology and enhance performance thereof in consideration of the services that the 5G mobile communication technology has initially intended to support, and physical layer standardization is in progress for technologies such as V2X (Vehicle-to-Everything) that aims to help a self-driving vehicle to make driving decisions based on its own location and status information transmitted by vehicles and to increase user convenience, new radio unlicensed (NR-U) for the purpose of system operation that meets various regulatory requirements in unlicensed bands, low power consumption scheme for NR terminals (UE power saving), non-terrestrial network (NTN) as direct terminal-satellite communication to secure coverage in an area where communication with a terrestrial network is not possible, and positioning.

In addition, standardization in radio interface architecture/protocol is in progress for technologies such as intelligent factories (industrial Internet of things, IIoT) for new service support through linkage and convergence with other industries, integrated access and backhaul (IAB) that provides nodes for network service area extension by integrating and supporting wireless backhaul links and access links, mobility enhancement including conditional handover and dual active protocol stack (DAPS) handover, 2-step random access (2-step RACH for NR) that simplifies the random access procedure; and standardization in system architecture/service is also in progress for the 5G baseline architecture (e.g., service based architecture, service based interface) for integrating network functions virtualization (NFV) and software defined networking (SDN) technologies, and mobile edge computing (MEC) where the terminal receives a service based on its location.

When such a 5G mobile communication system is commercialized, connected devices whose number is explosively increasing will be connected to the communication networks; accordingly, it is expected that enhancement in function and performance of the 5G mobile communication system and the integrated operation of the connected devices will be required. To this end, new research will be conducted regarding 5G performance improvement and complexity reduction, AI service support, metaverse service support, and drone communication by utilizing extended reality (XR) for efficiently supporting augmented reality (AR), virtual reality (VR), and mixed reality (MR), artificial intelligence (AI), and machine learning (ML).

Further, such advancement of 5G mobile communication systems will be the basis for the development of technologies such as new waveforms for ensuring coverage in the terahertz band of 6G mobile communication technology, full dimensional MIMO (FD-MIMO), multi-antenna transmission such as array antenna or large scale antenna, metamaterial-based lenses and antennas for improved coverage of terahertz band signals, high-dimensional spatial multiplexing using orbital angular momentum (OAM), reconfigurable intelligent surface (RIS) technique, full duplex technique to improve frequency efficiency and system network of 6G mobile communication technology, satellites, AI-based communication that utilizes artificial intelligence (AI) from the design stage and internalizes end-to-end AI support functions to realize system optimization, and next-generation distributed computing that realizes services whose complexity exceeds the limit of terminal computing capabilities by utilizing ultra-high-performance communication and computing resources.

A terminal in communication systems to which the disclosure can be applied has various communication modules. These modules may transmit and receive necessary data through respectively connected antennas. If the communication systems use different but adjacent frequency bands, interference may occur between the communication modules.

Therefore, to mitigate interference occurring when a terminal having various communication modules uses adjacent bands, it is necessary to control transmission power between the communication modules.

### DISCLOSURE OF INVENTION

### Technical Problem

The disclosure relates to a method for a terminal in a wireless communication system to solve the in-device coexistence problem.

More specifically, the disclosure is to provide a method and device for controlling the transmission power of each communication module in order to control interference that may occur between communication modules in a wireless communication system.

### Solution to Problem

The disclosure is intended to solve the above problems. So, a method performed by a terminal connected to plural cell groups in a wireless communication system may include: receiving, from a base station, autonomous denial-related configuration information to solve an in-device coexistence (IDC) problem for each of the plural cell groups; determining whether an IDC problem has occurred for each of the plural cell groups; and suspending, upon determining that the IDC problem has occurred in a specific cell group among the plural cell groups, uplink transmission in the specific cell group based on autonomous denial-related configuration information set for the specific cell group in which the IDC problem has occurred.

The disclosure is intended to solve the above problems. So, a method performed by a base station in a wireless communication system may include: obtaining, for solving in-device coexistence (IDC) problems, autonomous denial-related configuration information including configuration information related to autonomous denial of a first cell group and configuration information related to autonomous denial of a second cell group; transmitting the autonomous denial-related configuration information to a terminal; and suspending, in case that an IDC problem has occurred in the terminal in relation to a specific cell group among the first cell group and the second cell group, reception of uplink transmission based on autonomous denial-related configuration information corresponding to the specific cell group in which the IDC problem has occurred.

The disclosure is intended to solve the above problems. So, a terminal connected to plural cell groups in a wireless communication system may include: a transceiver configured to transmit and receive signals; and a controller, wherein the controller may be configured to receive, from a base station, autonomous denial-related configuration information to solve an in-device coexistence (IDC) problem for each of the plural cell groups, determine whether an IDC problem has occurred for each of the plural cell groups, and suspend, upon determining that the IDC problem has occurred in a specific cell group among the plural cell groups, uplink transmission in the specific cell group based on autonomous denial-related configuration information set for the specific cell group in which the IDC problem has occurred. The disclosure is intended to solve the above problems. So, a base station in a wireless communication system may include: a transceiver configured to transmit and receive signals; and a controller, wherein the controller may be configured to obtain, for solving in-device coexistence (IDC) problems, autonomous denial-related configuration information including configuration information related to autonomous denial of a first cell group and configuration information related to autonomous denial of a second cell group, transmit the autonomous denial-related configuration information to a terminal, and suspend, in case that an IDC problem has occurred in the terminal in relation to a specific cell group among the first cell group and the second cell group, reception of uplink transmission based on autonomous denial-related configuration information corresponding to the specific cell group in which the IDC problem has occurred.

### Advantageous Effects of Invention

According to the disclosure, the terminal in a wireless communication system may more efficiently solve the in-device coexistence problem.

More specifically, while information about a frequency experiencing an IDC problem may be reported on a frequency (carrier) basis in related art, according to an embodiment of the disclosure, more than one BWP or PRB may be reported on one NR frequency.

According to another embodiment of the disclosure, the terminal may report preferred DRX pattern information thereof to the base station with respect to secondary DRX.

According to another embodiment of the disclosure, when the IDC problem occurs only for a specific frequency/BWP/PRB, the operation of logging measurement information affected by the IDC problem may be suspended, and an indication indicating presence of an excluded measurement result or frequency/BWP/PRB information excluded from the log may be included in the log.

According to various embodiments of the disclosure, there is an effect of efficiently solving the IDC problem by improving the method of reporting IDC-related information and the preferred solution of the terminal.

The effects that may be obtained from the disclosure are not limited to those mentioned above, and other effects not mentioned above will be clearly understood by those skilled in the art to which the disclosure pertains from the following description.

### BRIEF DESCRIPTION OF DRAWINGS

FIG. 1A is a diagram showing the architecture of a next-generation mobile communication system according to an embodiment of the disclosure.

FIG. 1B is a flow diagram of a process in which the UE reports specific information about its preferences to the base station in a mobile communication system according to an embodiment of the disclosure.

FIG. 1C is a diagram for describing in-device coexistence (IDC) according to an embodiment of the disclosure.

FIG. 1D is a diagram illustrating frequency bands adjacent to the industrial scientific and medical (ISM) band among the frequencies used for mobile communication in 3GPP according to an embodiment of the disclosure.

FIG. 1E is a flow diagram of a process for reporting specific IDC information to the base station in a mobile communication system according to an embodiment of the disclosure.

FIG. 1F is a flowchart of UE operations according to an embodiment of the disclosure.

FIG. 1G is a flowchart of base station operations according to an embodiment of the disclosure.

FIG. 1H is a block diagram showing the internal structure of a UE according to an embodiment of the disclosure.

FIG. 1I is a block diagram showing the structure of a base station according to an embodiment of the disclosure.

### MODE FOR THE INVENTION

In the description of embodiments of this specification, descriptions of technical details well known in the art and not directly related to the disclosure may be omitted. This is to more clearly convey the gist of the disclosure without obscurities by omitting unnecessary descriptions.

Likewise, in the drawings, some elements are exaggerated, omitted, or only outlined in brief. Also, the size of each element does not necessarily reflect the actual size. The same reference symbols are used throughout the drawings to refer to the same or corresponding parts.

Advantages and features of the disclosure and methods for achieving them will be apparent from the following detailed description of embodiments taken in conjunction with the accompanying drawings. However, the disclosure is not limited to the embodiments disclosed below but may be implemented in various different ways, the embodiments are provided only to complete the disclosure and to fully inform the scope of the disclosure to those skilled in the art to which the disclosure pertains, and the disclosure is defined only by the scope of the claims. The same reference symbols are used throughout the specification to refer to the same parts.

Meanwhile, it is known to those skilled in the art that blocks of a flowchart (or sequence diagram) and a combination of flowcharts may be represented and executed by computer program instructions. These computer program instructions may be loaded on a processor of a general purpose computer, special purpose computer or programmable data processing equipment. When the loaded program instructions are executed by the processor, they create a means for carrying out functions described in the flowchart. As the computer program instructions may be stored in a computer readable memory that is usable in a specialized computer or a programmable data processing equipment, it is also possible to create articles of manufacture that carry out functions described in the flowchart. As the computer program instructions may be loaded on a computer or a programmable data processing equipment, when executed as processes, they may carry out steps of functions described in the flowchart.

A block of a flowchart may correspond to a module, a segment or a code containing one or more executable instructions implementing one or more logical functions, or to a part thereof. In some cases, functions described by blocks may be executed in an order different from the listed order. For example, two blocks listed in sequence may be executed at the same time or executed in reverse order.

In the description, the word “unit”, “module” or the like may refer to a software component or hardware component such as an FPGA or ASIC capable of carrying out a function or an operation. However, “unit” or the like is not limited to hardware or software. A unit or the like may be configured so as to reside in an addressable storage medium or to drive one or more processors. Units or the like may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose large components and units. Components and units may be configured to drive a device or one or more processors in a secure multimedia card.

In the following description of the disclosure, if a detailed description of a related well-known function or configuration is determined to unnecessarily obscure the gist of the disclosure, the detailed description will be omitted. Hereinafter, embodiments of the disclosure will be described with reference to the accompanying drawings.

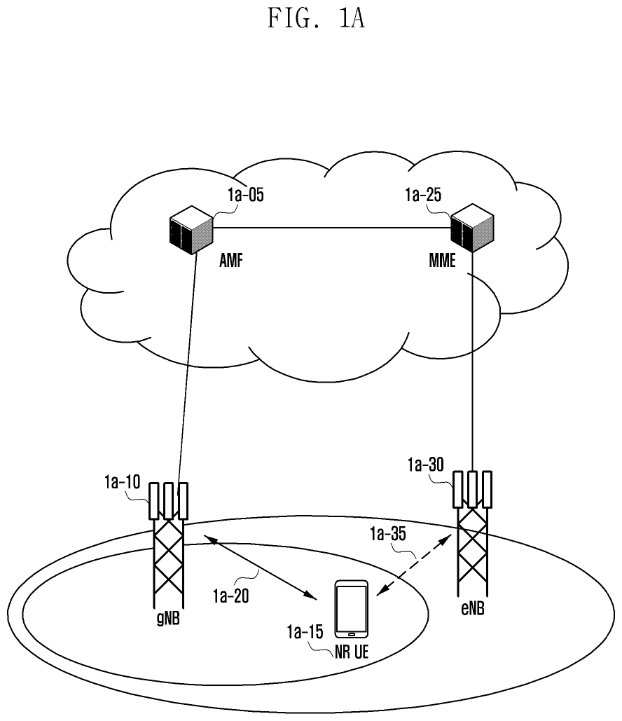

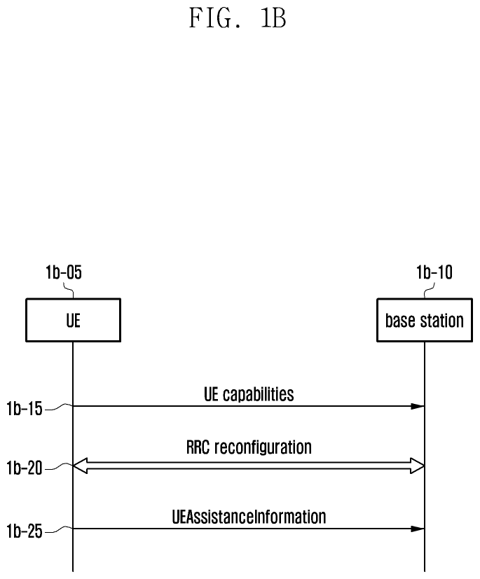

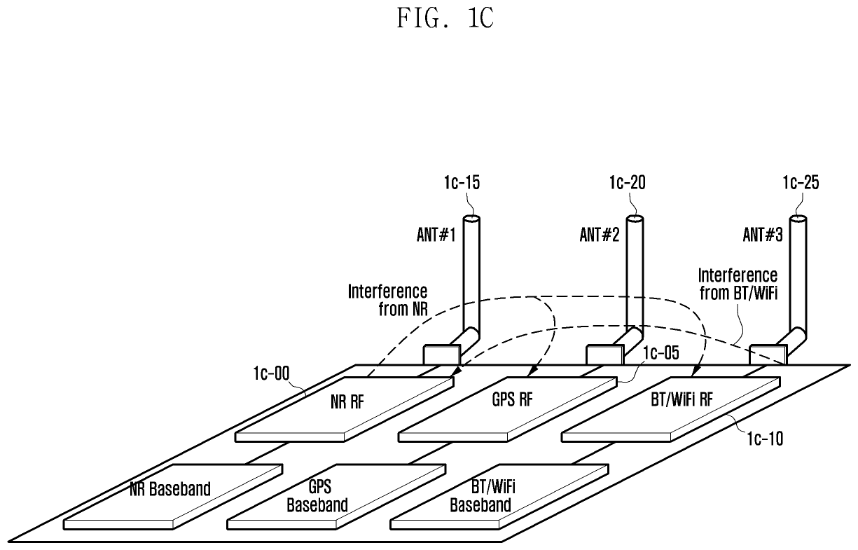

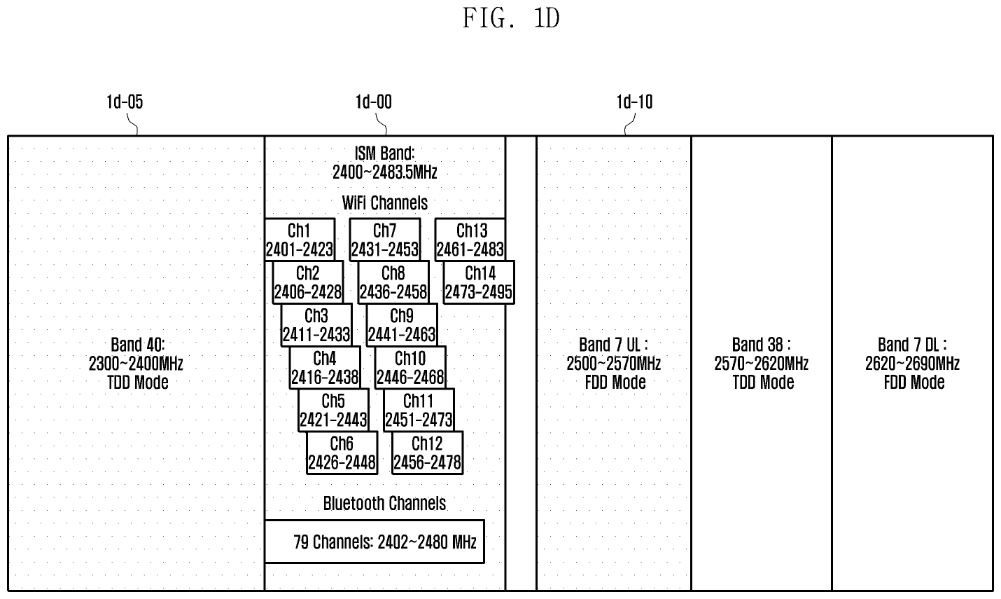

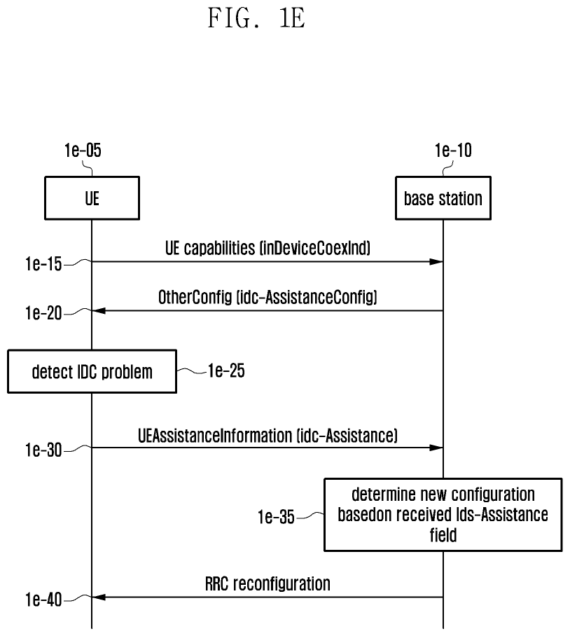

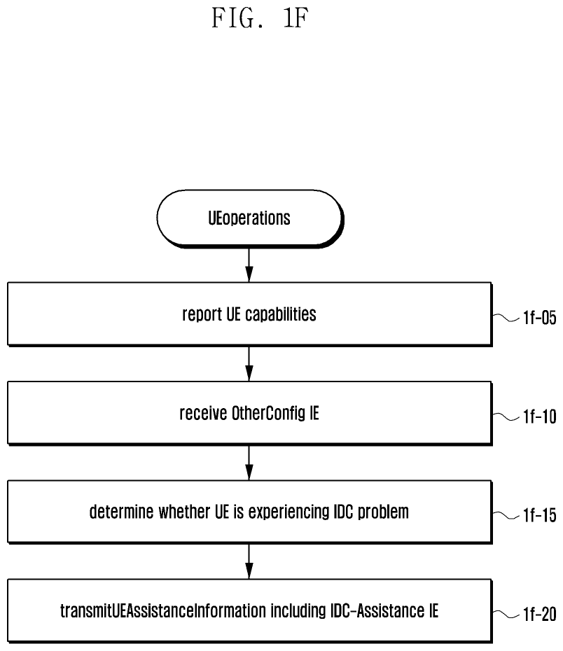

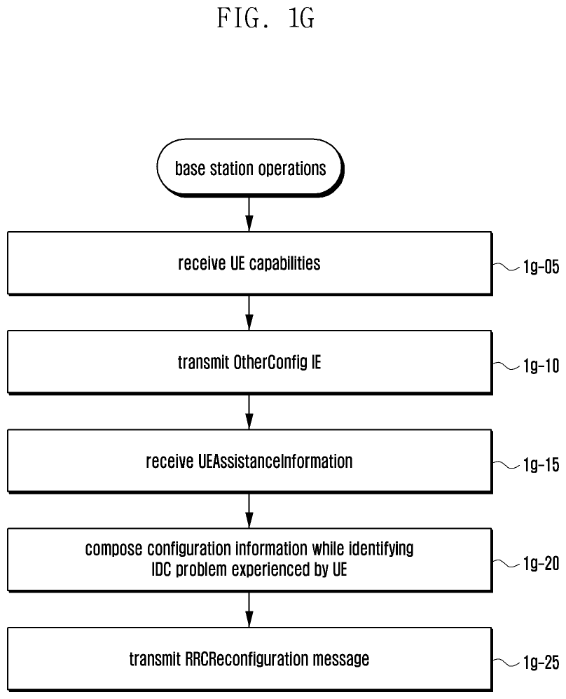

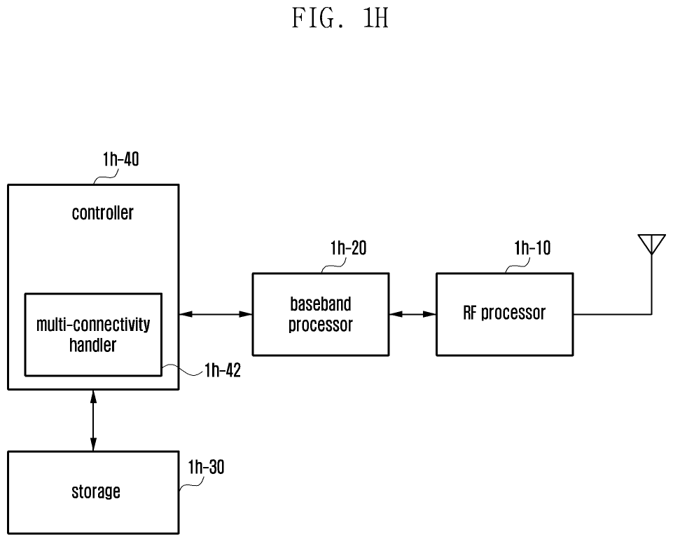

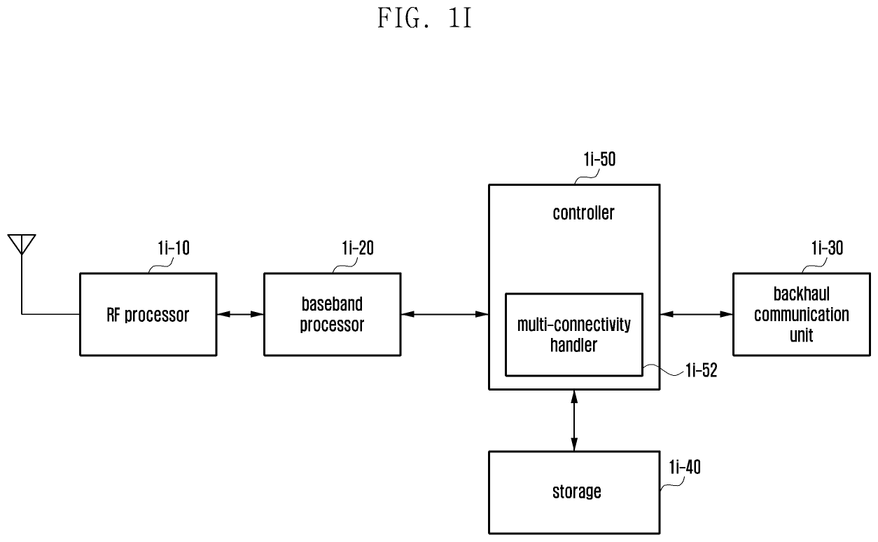

FIG. 1A is a diagram showing the architecture of a next-generation mobile communication system according to an embodiment of the disclosure.

With reference to FIG. 1A, as shown, the radio access network of the next-generation mobile communication system (New Radio, NR) is composed of a next-generation base station (NR node B, hereinafter gNB) 1a-10 and an access and mobility management function (AMF) 1a-05 (NR core network). An NR user equipment (hereinafter, NR UE or terminal) 1a-15 connects to an external network through the gNB 1a-10 and the AMF 1a-05.

In FIG. 1A, the gNB corresponds to an evolved node B (eNB) of the existing LTE system. The gNB may be connected to the NR UE through a radio channel, and it may provide a more superior service than that of the existing node B (1a-20). All user traffic is serviced through shared channels in the next-generation mobile communication system. Hence, there is a need for an entity that performs scheduling by collecting status information, such as buffer states, available transmission power states, and channel states of individual UEs, and the gNB 1a-10 takes charge of this.

In a typical situation, one gNB controls a plurality of cells. To implement ultra-high-speed data transmission compared with current LTE, a bandwidth beyond the existing maximum bandwidth may be utilized, orthogonal frequency division multiplexing (OFDM) may be used as a radio access technology, and beamforming technology may be additionally used in combination. Further, an adaptive modulation and coding (AMC) scheme determining a modulation scheme and channel coding rate to match the channel state of the UE may be applied.

The AMF 1a-05 performs functions such as mobility support, bearer configuration, and quality of service (QOS) configuration. The AMF is an entity taking charge of not only mobility management but also various control functions for the UE, and is connected to a plurality of base stations. In addition, the next-generation mobile communication system may interwork with the existing LTE system, and the AMF is connected to the MME 1a-25 through a network interface. The MME is connected to an eNB 1a-30 being an existing base station. A UE supporting LTE-NR dual connectivity (EN-DC) may transmit and receive data while maintaining connectivity to not only the gNB but also the eNB (1a-35).

FIG. 1B is a flow diagram of a process in which the UE reports specific information about its preferences to the base station in a mobile communication system according to an embodiment of the disclosure.

In the NR mobile communication system, the UE may report its preferences compared to the current settings to the base station. For example, the preferences may be about delay budget, power consumption (UE power preference), heat generation (overheating assistance), in-device coexistence (IDC) problem reporting and solution (IDC assistance), or the like.

Upon receiving the preference information, the base station may trigger reconfiguration. For example, upon receiving a preference report for reduced power consumption, reduced delay, or reduced heat generation, the base station may perform reconfiguration by decreasing or increasing the discontinuous reception (DRX) periodicity.

The UE may report a delay budget preference and heat reduction preference to the base station. Additionally, the UE may report preferred reconfiguration items in more detail for reducing heat generation or power consumption. At this time, the maximum number of secondary cells (SCell), aggregated bandwidth (BW), and maximum number of multiple input multiple output (MIMO) layers preferred by the UE may be indicated.

In a procedure for reporting the above preferences, first, at step 1b-15, the UE 1b-05 reports to the base station 1b-10 that it has the capability to report each of the above items. (UE capabilities)

At step 1b-20, based on the capability information, the base station 1b-10 configures settings so that the UE 1b-05 may report each preference to the base station 1b-10 when necessary. (RRC reconfiguration)

At step 1b-25, the UE 1b-05 reports its preference to the base station 1b-10 at a necessary time by using a UEAssistanceInformation message. (UEAssistanceInformation)

FIG. 1C is a diagram for describing in-device coexistence (IDC) technique according to an embodiment of the disclosure.

In-device coexistence (IDC) technique is a technology that minimizes interference that may arise between multiple communication modules present in one device.

Recently, UEs have diverse functions, and a UE may include various communication modules to support them. In addition to a new radio (NR) communication module 1c-00, there may be a global positioning system (GPS) module 1c-05, and a short-range communication module 1c-10 such as Bluetooth, or wireless LAN. These modules transmit and receive necessary data through respectively connected antennas 1c-15, 1c-20 and 1c-25 and the like.

If communication systems use different but adjacent frequency bands, interference may occur between communication modules. This is because signals transmitted and received between bands cannot be ideally separated. Furthermore, since the communication modules and their connected antennas are included in one terminal device, they are located very close together. Hence, the intensity of interference between them may be relatively large. Therefore, to alleviate this interference, it is necessary to control transmission power between the communication modules.

For example, in the NR uplink, when the short-range communication module 1c-10 such as Bluetooth or wireless LAN attempts to receive data, the transmission signal of the NR communication module 1c-00 may cause interference to the short-range communication module. Additionally, the NR uplink signal may cause interference to other NR frequencies or frequencies of other mobile communication systems. To alleviate this, the amount of interference can be controlled by limiting the maximum uplink transmission power of the NR communication module. Alternatively, the operation of the NR communication module may be temporarily suspended to eliminate the amount of interference power affecting the short-range communication module. Conversely, in the NR downlink, the short-range communication module 1c-10 may cause interference to the received signal of the NR communication module 1c-00.

FIG. 1D is a diagram illustrating frequency bands adjacent to the industrial scientific and medical (ISM) band among the frequencies used for mobile communication in 3GPP according to an embodiment of the disclosure.

It can be seen that interference becomes severe when the mobile communication cell uses Band 40 (1d-05) and the wireless LAN uses Channel 1, and interference becomes severe when the mobile communication cell uses Band 7 (1d-10) and the wireless LAN uses Channel 13 or 14. Therefore, when such interference occurs, a method for appropriately avoiding it is needed.

In existing New Radio (NR), depending on the base station settings, the UE may report, to the base station, a UEAssistanceInformation message including information about NR frequencies being affected by an in-device coexistence (IDC) problem (affectedCarrierFreqList field), information about an NR frequency experiencing an IDC problem due to inter-modulation distortion and harmonics of an uplink NR signal with configured carrier aggregation (CA) (affectedCarrierFreqCombList field), or information about heterogeneous communication modules such as global positioning system (GPS), Bluetooth (BT), and WLAN.

The disclosure proposes a method for a UE to report improved IDC-related information and preferred solution. In particular,
Method of reporting an IDC problem occurring between 3GPP and non-3GPP systems in an MR-DC scenario,
Method of reporting an IDC problem in detail on a bandwidth part (BWP) or physical resource block (PRB) basis compared to the existing one,
Method of reporting a time division multiplexing (TDM)-based solution preferred by the UE,
Method of introducing an autonomous denial function for NR, and
Method of improving self-organizing networks (SON)/minimization of drive test (MDT) in consideration of an IDC problem

The disclosure is characterized by proposing the above methods.

In addition, new UE capability information and configuration information are introduced for this purpose.

The autonomous denial function refers to a technology in which the UE itself temporarily suspends uplink transmission that is expected to cause an IDC problem for a specific period of time.

FIG. 1E is a flow diagram of a process for reporting specific in-device coexistence (IDC) information to the base station in a mobile communication system according to an embodiment of the disclosure.

At step 1e-15, the UE 1e-05 reports to the base station (gNB) 1e-10 that it has a capability to report specific in-device coexistence (IDC) information. At this time, an indicator indicating the above capability is reported to the base station. The capability to report IDC information may be specified in detail and reported to the base station. (UE capabilities (IndeviceCoexInd))

For example, whether a frequency division multiplexing (FDM) or time division multiplexing (TDM) based solution preferred by the UE can be reported, whether DRX configuration information preferred by the UE can be reported for each cell group (CG) or discontinuous reception (DRX) group, whether a frequency range affected by an IDC problem or causing an IDC problem can be reported on a bandwidth part (BWP) basis, whether a frequency range affected by an IDC problem or causing an IDC problem can be reported on a physical resource block (PRB) basis, whether the autonomous denial function is supported, and the like may be included.

Each UE capability information is regarded as optional with signaling or optional without signaling.

At step 1e-20, the base station 1e-10 may configure the UE 1e-05 to report specific information to the base station 1e-10. (OtherConfig (idc-AssistanceConfig)) The base station 1e-10 configures the UE 1e-05 with a specific indicator indicating that the UE 1e-05 can report specific information to base station 1e-10 through IE idc-AssistanceConfig.

When this IE is configured, this indicates that the UE 1e-05 may report information about a new radio (NR) frequency experiencing an IDC problem, or indicates that when uplink carrier aggregation is configured, the UE 1e-05 may report that an IDC problem due to inter-modulation distortion/harmonics from an NR frequency has occurred in another NR frequency or another communication module.

In particular, the above IE includes a list of frequencies that can be reported among the NR frequencies experiencing an IDC problem. The above list is included in IE CandidateServingFreqListNR, and each frequency belonging to the list is indicated by IE ARFCN-ValueNR indicating one center frequency. Even if experiencing an IDC problem, a frequency not belonging to the above list need not be reported. If the above IE is not provided, the UE reports information about a frequency experiencing an IDC problem among the NR frequencies supported by it to the base station.

This disclosure additionally proposes the following configuration information to be included in idc-AssistanceConfig.
A configuration indication indicating whether the UE can report its preferred FDM or TDM-based solution,
A configuration indication indicating whether the UE can report preferred DRX configuration information on a cell group (CG) or DRX group basis,
A configuration indication indicating whether the frequency range affected by an IDC problem or causing an IDC problem can be reported on a BWP basis,
A configuration indication indicating whether the frequency range affected by an IDC problem or causing an IDC problem can be reported on a PRB basis,
Configuration information required to perform the autonomous denial function

The above items may be included.

If the configuration indication(s) or configuration information is included in IE idc-AssistanceConfig, the UE may report information or perform a function corresponding to the indication.

The configuration information necessary to perform the autonomous denial function according to an embodiment of the disclosure includes the number of uplink subframes, uplink slots, uplink symbols, or information about uplink transmission time (e.g., in ms) in which the UE is allowed to consecutively perform autonomous denial, and information on the time duration in which the autonomous denial operation may be applied (autonomous denial validity).

The unit for the autonomous denial validity may be an uplink subframe, an uplink slot, an uplink symbol, or an absolute uplink transmission time (e.g., in ms).

When an IDC problem occurs, to eliminate or alleviate the IDC problem, the UE may temporarily suspend specific uplink transmissions for the maximum time set above for consecutive autonomous denials.

The base station may provide the autonomous denial configuration information on a basis of cell group (or MAC entity), frequency, cell, BWP, PRB, or

DRX group.

Hence, the base station may selectively allow the autonomous denial function to the UE. For example, if a service sensitive to transmission delay is provided in a specific cell, the base station may not configure the autonomous denial function to the cell.

If an IDC problem occurs, the UE 1e-05 may temporarily suspend uplink transmission in the cell, BWP, or PRB belonging to the above cases according to the corresponding configuration information. Therefore, depending on each case, indication information to indicate this may be provided together as follows.

Per cell group: MCG and/or SCG index, applicable for all MR-DC types (even for EN-DC)
Per freq: ARFCN-Value or meas object id
Per FR: FR1 or FR2 index
Per cell: ServCellIndex, CGI or PCI
Per BWP/PRB: BWP id or locationAndBandwidth field for BWP, and startPRB and nroPRBs fields for PRB (detailed scheme of indicating BWP or PRB will be described later)
Per DRX group: default and/or secondary (per CG) index

At step 1e-25, if the UE 1e-05 experiences an IDC problem (identifying an IDC problem), at step 1e-30, IDC-related information is included in the idc-Assistance field, and this IE is included in a UEAssistanceInformation message, which is one RRC message, and is delivered to the base station 1e-10. (UEAssistanceInformation (Idc-Assistance))

In the related art, two fields may be included in the idc-Assistance field. One is the affectedCarrierFreqList field, which is used to indicate information about a frequency experiencing an IDC problem. The other is the affectedCarrierFreqCombList field, which is used, when uplink carrier aggregation is configured, to indicate another NR frequency or another communication module experiencing an IDC problem caused by inter-modulation distortion/harmonics of an NR frequency. In the affectedCarrierFreqList field and the affectedCarrierFreqCombList field, an NR frequency is indicated by ARFCN-ValueNR.

In this disclosure, the following information is proposed as new IDC-related information that the UE may report to the base station.
MR-DC assistance information
Affected BWP list or affected BWP combination list
Affected PRB list or affected PRB combination list
UE preferred DRX pattern information (DRX assistance info)
UE preferred TDM pattern information
Hardware sharing problem

Next, a detailed description will be given of IDC-related information that the UE can report to the base station according to an embodiment of the disclosure.
MR-DC assistance information

In MR-DC, the UE may report whether an IDC problem caused by inter-modulation distortion/harmonics of a configured NR or Long Term Evolution (LTE) frequency occurred in another NR or LTE frequency or communication module such as GPS, BT or WLAN. More specifically, information regarding the type of a system experiencing an IDC problem (victim system type, e.g., GPS, BT, WLAN), the direction of the IDC interference (interference direction), a list of NR frequencies and LTE frequencies affected by the IDC problem may be reported to the base station. At this time, the NR frequency and LTE frequency are indicated respectively by ARFCN-ValueNR and ARFCN-ValueEUTRA.

The above information is included in new IE MRDC-AssistanceInfo, and the new IE is included in a UEAssistanceInformation message and reported by the UE to the base station.
Affected BWP list or affected BWP combination list/Affected PRB list or affected PRB combination list

In the related art, information about frequencies experiencing an IDC problem may be reported on a frequency (carrier) basis. In the disclosure, depending on the configuration, the UE may report a frequency range experiencing an IDC problem on a BWP or PRB basis to the base station.

The UE may report one or more BWPs or PRBs experiencing an IDC problem in one NR frequency. For example, affected BWP list, affected BWP combination list, affected PRB list, or affected PRB combination list may be introduced as new information to be included in a UEAssistanceInformation message.

Affected BWP list or Affected PRB list is used to report information about one or more BWPs or PRBs experiencing an IDC problem. Affected BWP list or Affected PRB list may also include information about the direction of IDC interference (interference direction).

Meanwhile, affected BWP combination list or affected PRB combination list is used to indicate a BWP or PRB experiencing an IDC problem caused by inter-modulation distortion/harmonics of an NR frequency in CA or MR-DC. There may be several options to indicate a BWP or PRB experiencing an IDC problem in Affected BWP list or affected BWP combination list, Affected PRB list or affected PRB combination list being newly introduced information.

According to an embodiment of the disclosure, as a method of indicating a BWP, usage of a BWP ID, usage of a locationAndBandwidth field, and introduction of specific bitmap information are proposed.

### Option 1: Utilizing BWP ID

The base station may configure multiple BWPs for one serving cell. To identify BWPs, the base station assigns a BWP-id to each BWP. The UE may use a preset BWP-id to indicate the BWP experiencing an IDC problem. However, since the BWP ID is valid only within one cell (i.e., ID reused for each cell), the BWP ID may be reported together with the cell ID (e.g., serving cell index, CGI or PCI information) or cell frequency information (e.g., ARFCN-ValueNR) corresponding to the BWP.

Option 2: Utilizing locationAndBandwidth Field

In NR standards, the locationAndBandwidth field is used to indicate the frequency domain position and bandwidth of a bandwidth part (BWP). The UE may use this field to indicate a BWP experiencing an IDC problem.

### Option 3: Introducing New Bitmap Information

A bitmap composed of bits corresponding to individual BWPs configured in one carrier (or cell) is introduced. If one BWP is experiencing an IDC problem, this state may be indicated by setting the bit corresponding to the BWP to a value of ‘0’ or ‘1’. The bitmap may be reported together with the corresponding cell ID (e.g., serving cell index, CGI or PCI information) or cell frequency information (e.g., ARFCN-ValueNR).

According to an embodiment of the disclosure, as a method of indicating a PRB, usage of a PRB ID, usage of startPRB and nrofPRBs fields, and introduction of specific bitmap information are proposed.

Option 1: Utilizing PRB ID Set to Identify PRB within One Carrier

The base station may set a PRB ID to indicate the position of a physical resource block (PRB) within one carrier. The UE may use a preset BWP ID to indicate the BWP experiencing an IDC problem. However, since the BWP ID is valid only within one cell (i.e., ID reused for each cell), the BWP ID may be reported together with the cell ID (e.g., serving cell index, CGI or PCI information) or cell frequency information (e.g., ARFCN-ValueNR) corresponding to the BWP.

Option 2: Utilizing startPRB Field and nrofPRBs Field

The startPRB and nrofPRBs fields may be used to indicate one or more consecutive PRBs that are affected by an IDC problem. The startPRB field is index information indicating one PRB, and the nrofPRBs field is a value indicating the number of PRBs. Here, the startPRB field with an index value of ‘0’ may indicate the first PRB of one BWP or the first PRB of one carrier.

### Option 3: Introducing New Bitmap Information

A bitmap composed of bits corresponding to individual PRBs belonging to one carrier (or cell) or one BWP is introduced. If one PRB is experiencing an IDC problem, this state may be indicated by setting the bit corresponding to the PRB to a value of ‘0’ or ‘1’. The first bit corresponds to the first PRB belonging to the carrier or BWP. The bitmap may be reported together with the corresponding cell ID (e.g., serving cell index, CGI or PCI information) or cell frequency information (e.g., ARFCN-ValueNR) and BWP information.

The above options of indicating BWPs and PRBs may be applied alone or in combination.

### Ue Preferred DRX Pattern Information (DRX Assistance Info)

To eliminate or alleviate an IDC problem, the UE may report its preferred DRX pattern information to the base station.

The DRX pattern information is composed of fields drx-cycleLength, drx-Offset, and drx-ActiveTime. The drx-cycleLength field indicates the DRX cycle length value preferred by the UE. The drx-Offset field indicates the DRX start offset value preferred by the UE. The drx-ActiveTime field indicates the active time value preferred by the UE.

In the disclosure, it is characterized in that the drx-cycleLength and drx-ActiveTime values are set in absolute time (e.g., ms), and the drx-Offset field is set in units of subframes, slots, or symbols.

In general, DRX may be configured for each MAC entity. For example, in dual connectivity (DC), a MAC entity is present for each of the MN and SN, so a UE in DC state may be configured with two DRX settings for the MAC entities.

Hence, in the disclosure, it is proposed that the UE provides plural pieces of preferred DRX pattern information. For example, the UE may report different pieces of preferred DRX pattern information for different cell groups, DRX groups, or frequency ranges (FRs). At this time, new indicators may also be reported to the base station to identify each piece of pattern information.
Per cell group: MCG and/or SCG index, applicable for all MR-DC types (even for EN-DC)
Per DRX group: default and/or secondary (per CG) index
Per FR: FR1 or FR2 index

In particular, NR has been improved to allow secondary DRX to be configured in one MAC entity. That is, the base station may configure two sets of DRX configuration information, default DRX and secondary DRX, to the UE. However, secondary DRX configuration information may include Drx-onDurationTimer and drx-InactivityTimer only. The remaining configuration information such as DRX cycle follows the default DRX configuration information. This is to exclude complexity that may arise due to changes in the DRX cycle, or the like.

In this disclosure, it is characterized in that the UE may report its preferred DRX pattern information to the base station even for secondary DRX. Since the drx-ActiveTime value in DRX assistance info may affect Drx-onDurationTimer and drx-InactivityTimer in secondary DRX, the UE may report the drx-ActiveTime field only as preferred pattern information for secondary DRX. However, if the UE does not report preferred pattern information for default DRX to the base station, all DRX assistance info may be included in the preferred pattern information for secondary DRX.

The above information is included in new IE drx-AssistanceInfo, and the new IE is included in a UEAssistanceInformation message and reported by the UE to the base station. Meanwhile, for the purpose of UE power saving, the UE may report its preferred DRX configuration information to the base station via a UEAssistanceInformation message (see below). The following IE may be reused as UE preferred pattern information for solving an IDC problem.

| | |
|---|---|
| [symbol] DRX-Preference-r16 ::= | SEQUENCE { [symbol] |
| preferredDRX-InactivityTimer-r16 | ENUMERATED { [symbol] |
| | ms0, ms1, ms2, ms3, ms4, ms5, ms6, ms8, ms10, ms20, ms30, ms40, ms50, |

ms60, ms80,

[symbol]

ms100, ms200, ms300, ms500, ms750, ms1280, ms1920, ms2560, spare9,

spare8,

[symbol]

| | |
|---|---|
| | spare7, spare6, spare5, spare4, spare3, spare2, spare1 [symbol] OPTIONAL, [symbol] |
| preferredDRX-LongCycle-r16 | ENUMERATED { [symbol] |
| | ms10, ms20, ms32, ms40, ms60, ms64, ms70, ms80, ms128, ms160, ms256, |

ms320, ms512,

[symbol]

ms640, ms1024, ms1280, ms2048, ms2560, ms5120, ms10240, spare12,

spare11, spare10,

[symbol]

spare9, spare8, spare7, spare6, spare5, spare4, spare3, spare2,

spare1 } OPTIONAL,

[symbol]

| | |
|---|---|
| preferredDRX-ShortCycle-r16 | ENUMERATED { [symbol] |
| | ms2, ms3, ms4, ms5, ms6, ms7, ms8, ms10, ms14, ms16, ms20, ms30, ms32, [symbol] |
| | ms35, ms40, ms64, ms80, ms128, ms160, ms256, ms320, ms512, ms640, |

spare9,

[symbol]

spare8, spare7, spare6, spare5, spare4, spare3, spare2, spare1 }

OPTIONAL,

[symbol]

| | |
|---|---|
| preferredDRX-ShortCycleTimer-r16 | INTEGER (1..16) OPTIONAL [symbol] |

} [symbol] [symbol]
indicates data missing or illegible when filed

### UW Preferred TDM Pattern Information

The UE may report its preferred TDM pattern information to the base station to eliminate or alleviate the IDC problem. The TDM pattern information may have a bit string format, and each bit may correspond to one subframe, slot, symbol, or a specific unit time. The above pattern represents N subframes, slots, symbol lengths, or specific unit times, and may start from a specific point in time and may be repeated one after another. The start of the pattern may be determined according to SFN mod x=0 or a specific equation. For example, the specific equation may be as follows.

$$[ SFN * 10 + subframe number ] mod X = offset 1 , and \text{/} or \\ [ SFN * number of slots per radio frame + slot number ] mod X = offset 2$$

Here, X may be subframes or slots depending on the applied equation, and offset1 and offset2 values may be set by the base station or may be defined in advance. The above two equations may be considered alone or in combination.

The UE may report plural pieces of TDM pattern information to the base station. That is, it may be provided per cell group (or MAC entity), frequency, cell, BWP, PRB, or DRX group. At this time, to identify these cases, the following indicators may also be reported.
Per cell group: MCG and/or SCG index, applicable for all MR-DC types (even for EN-DC)
Per freq: ARFCN-Value or meas object id
Per FR: FR1 or FR2 index
Per cell: ServCellIndex, CGI or PCI
Per BWP/PRB: BWP id or locationAndBandwidth field for BWP, and startPRB and nroPRBs fields for PRB (the method of indicating BWP or PRB has been described in detail above)

Per DRX group: default and/or secondary (per CG) index

### Hardware Sharing Problem

The UE may report indication information indicating that there is a problem with hardware sharing to the base station. At this time, the UE may also report the type of systems that have problems with hardware sharing (e.g., NR, LTE, GPS, BT, WLAN, . . . ), or information about NR or LTE frequencies that cause problems with hardware sharing.

At step 1e-35, upon receiving the above information, the base station 1e-10 analyzes the IDC problem experienced by the UE 1e-05 and determines to perform reconfiguration to eliminate or alleviate it. (Building new configuration based on the received Idc-Assistance field)

At step 1e-40, the base station 1-e01 transmits reconfiguration information to the UE 1e-05 by using a RRCReconfiguration message. (RRCReconfiguration)

When the UE 1e-05 experiences an IDC problem, it may be performing logged minimization of drive tests (MDT) operation. Logged MDT is a technology in which a UE periodically records information necessary for network optimization and reports it to the base station. In the related art, when an IDC problem occurs, the UE suspends logged MDT operation and includes an indication indicating contamination due to the IDC problem in the log affected by the IDC problem.

However, if an IDC problem occurs only for a specific frequency, BWP, or PRB, it is more efficient to exclude only the measurement information contaminated by the IDC problem from the log rather than suspending logged MDT operation.

Hence, according to an embodiment of the disclosure, in the log recorded during a period when an IDC problem has occurred, measurement information affected by the IDC problem may be excluded from the log, and an indication indicating that there is a measurement result excluded due to the IDC problem may be included. Alternatively, frequency information excluded from the log due to the IDC problem may be included in the log.

The UE reports its capability information to the base station, and the capability information includes an indication indicating that logged MDT operation may be performed when an IDC problem occurs. The base station may use a LoggedMeasurementConfiguration message to configure the UE to perform logged MDT operation even when an IDC problem occurs.

When the UE transitions to the RRC_IDLE or RRC_INACTIVE state, it performs logged MDT operation according to the configuration information. At this time, upon recognizing that an IDC problem has occurred only for a specific frequency, BWP, or PRB, the UE stops logging measurement information affected by the IDC problem. Instead, the UE includes, in the log, an indication indicating that there are measurement results excluded due to the IDC problem, or frequency/BWP/PRB information excluded from the log due to the IDC problem.

The logged information may be reported to the base station through a UE information procedure (UEInformationRequest and UEInformationResponse messages) after the UE transitions to connected mode.

FIG. 1F is a flowchart of UE operations according to an embodiment of the disclosure.

At step 1f-05, the UE reports to the base station that it has the capability to report specific in-device coexistence (IDC) information. (Reporting UE capabilities)

At step 1f-10, the UE receives a RRCReconfiguration message from the base station. This message contains IE OtherConfig including IE idc-AssistanceConfig. IE idc-AssistanceConfig is used by the UE to configure reporting of the specific information. (Receiving OtherConfig IE)

At step 1f-15, the UE determines whether it is experiencing an IDC problem. (Evaluating If UE experiences IDC problem)

At step 1f-20, the UE transmits a UEAssistanceInformation message including the above proposed information. (Transmitting UEAssistanceInformation including the IDC-Assistance IE)

FIG. 1G is a flowchart of base station operations according to an embodiment of the disclosure.

At step 1g-05, the base station receives UE capability information from the UE. (Receiving UE capabilities)

At step 1g-10, the base station transmits IE otherConfig including an idc-AssistanceConfig field to the UE. (Transmitting IE OtherConfig)

At step 1g-15, the base station receives a UEAssistanceInformation message from the UE. This message may include an IDC-Assistance field. (Receiving UEAssistanceinformation)

At step 1g-20, the base station composes configuration parameters based on the received information. (Building configuration while identifying IDC problem experienced by UE)

At step 1g-25, the base station includes the above configuration information in an RRCReconfiguration message and transmits the message to the UE. (Transmitting RRCReconfiguration)

FIG. 1H is a block diagram showing the internal structure of a UE according to an embodiment of the disclosure.

Referring to the drawing, the UE may include a radio frequency (RF) processor 1h-10, a baseband processor 1h-20, a storage 1h-30, and a controller 1h-40.

The RF processor 1h-10 performs a function for transmitting and receiving a signal through a radio channel, such as signal band conversion and amplification. That is, the RF processor 1h-10 performs up-conversion of a baseband signal provided from the baseband processor 1h-20 into an RF-band signal and transmits it through an antenna, and performs down-conversion of an RF-band signal received through an antenna into a baseband signal. For example, the RF processor 1h-10 may include a transmission filter, a reception filter, an amplifier, a mixer, an oscillator, a digital-to-analog converter (DAC), and an analog-to-digital converter (ADC). Although only one antenna is illustrated in the drawing, the UE may be provided with a plurality of antennas. Also, the RF processor 1h-10 may include a plurality of RF chains. Further, the RF processor 1h-10 may perform beamforming. For beamforming, the RF processor 1h-10 may adjust phases and magnitudes of signals transmitted and received through plural antennas or antenna elements. Further, the RF processor may perform MIMO, and may receive several layers during a MIMO operation.

The baseband processor 1h-20 performs conversion between a baseband signal and a bit stream in accordance with the physical layer specification of the system. For example, during data transmission, the baseband processor 1h-20 generates complex symbols by encoding and modulating a transmission bit stream. Further, during data reception, the baseband processor 1h-20 restores a reception bit stream by demodulating and decoding a baseband signal provided from the RF processor 1h-10. For example, in the case of utilizing orthogonal frequency division multiplexing (OFDM), for data transmission, the baseband processor 1h-20 generates complex symbols by encoding and modulating a transmission bit stream, maps the complex symbols to subcarriers, and composes OFDM symbols through inverse fast Fourier transform (IFFT) operation and cyclic prefix (CP) insertion. Further, for data reception, the baseband processor 1h-20 divides a baseband signal provided from the RF processor 1h-10 in units of OFDM symbols, restores the signals mapped to subcarriers through fast Fourier transform (FFT) operation, and reconstructs the reception bit stream through demodulation and decoding.

The baseband processor 1h-20 and the RF processor 1h-10 transmit and receive signals as described above. Hence, the baseband processor 1h-20 and the RF processor 1h-10 may be called a transmitter, a receiver, a transceiver, or a communication unit. Further, to support different radio access technologies, at least one of the baseband processor 1h-20 or the RF processor 1h-10 may include a plurality of communication modules. In addition, to process signals of different frequency bands, at least one of the baseband processor 1h-20 or the RF processor 1h-10 may include different communication modules. For example, the different radio access technologies may include a wireless LAN (e.g., IEEE 802.11), a cellular network (e.g., LTE), and the like. In addition, the different frequency bands may include a super high frequency (SHF) band (e.g., 2.NRHz, NRhz) and a millimeter wave (mmWave) band (e.g., 60 GHz).

The storage 1h-30 stores data such as basic programs, application programs, and configuration information for the operation of the UE. In particular, the storage 1h-30 may store information about a second access node that performs wireless communication using a second radio access technology. Also, the storage 1h-30 provides stored data in response to a request from the controller 1h-40.

The controller 1h-40 controls the overall operation of the UE. For example, the controller 1h-40 transmits and receives signals through the baseband processor 1h-20 and the RF processor 1h-10. Further, the controller 1h-40 writes or reads data to or from the storage 1h-40. To this end, the controller 1h-40 may include at least one processor. For example, the controller 1h-40 may include a communication processor (CP) for controlling communication and an application processor (AP) for controlling higher layers such as application programs.

FIG. 1I is a block diagram showing the structure of a base station according to an embodiment of the disclosure.

As shown in the drawing, the base station includes an RF processor 1i-10, a baseband processor 1i-20, a backhaul communication unit 1i-30, a storage 1i-40, and a controller 1i-50.

The RF processor 1i-10 performs a function for transmitting and receiving a signal through a radio channel, such as signal band conversion and amplification. That is, the RF processor 1i-10 performs up-conversion of a baseband signal provided from the baseband processor 1i-20 into an RF-band signal and transmits the converted signal through an antenna, and performs down-conversion of an RF-band signal received through an antenna into a baseband signal. For example, the RF processor 1i-10 may include a transmission filter, a reception filter, an amplifier, a mixer, an oscillator, a DAC, and an ADC. Although only one antenna is illustrated in the drawing, the first access node may be provided with a plurality of antennas. Additionally, the RF processor 1i-10 may include a plurality of RF chains. Further, the RF processor 1i-10 may perform beamforming. For beamforming, the RF processor 1i-10 may adjust phases and amplitudes of signals transmitted and received through plural antennas or antenna elements. The RF processor may perform downlink MIMO operation by transmitting one or more layers.

The baseband processor 1i-20 performs conversion between a baseband signal and a bit stream in accordance with the physical layer specification of a first radio access technology. For example, for data transmission, the baseband processor 1i-20 generates complex symbols by encoding and modulating a transmission bit stream. Further, for data reception, the baseband processor 1i-20 restores a reception bit stream by demodulating and decoding a baseband signal provided from the RF processor 1i-10. For example, in the case of utilizing OFDM, for data transmission, the baseband processor 1i-20 generates complex symbols by encoding and modulating a transmission bit stream, maps the complex symbols to subcarriers, and composes OFDM symbols through IFFT operation and CP insertion. Further, for data reception, the baseband processor 1i-20 divides a baseband signal provided from the RF processor 1i-10 in units of OFDM symbols, restores the signals mapped to subcarriers through FFT operation, and reconstructs the reception bit stream through demodulation and decoding. The baseband processor 1i-20 and the RF processor 1i-10 transmit and receive signals as described above. Hence, the baseband processor 1i-20 and the RF processor 1i-10 may be called a transmitter, a receiver, a transceiver, a communication unit, or a wireless communication unit.

The backhaul communication unit 1i-30 provides an interface for communication with other nodes in the network. That is, the backhaul communication unit 1i-30 converts a bit stream, which is to be transmitted from the primary base station to another node, for example, a secondary base station or the core network, into a physical signal, and converts a physical signal received from another node into a bit stream.

The storage 1i-40 stores data such as basic programs, application programs, and configuration information for the operation of the primary base station. In particular, the storage 1i-40 may store information on a bearer allocated to a connected UE and measurement results reported from the connected UE. Further, the storage 1i-40 may store information used as a criterion for determining whether to provide or suspend multi-connectivity to the UE. In addition, the storage 1i-40 provides stored data in response to a request from the controller 1i-50.

The controller 1i-50 controls the overall operation of the primary base station. For example, the controller 1i-50 transmits and receives signals through the baseband processor 1i-20 and the RF processor 1i-10 or through the backhaul communication unit 1i-30. Further, the controller 1i-50 writes or reads data to or from the storage 1i-40. To this end, the controller 1i-50 may include at least one processor.

The methods according to the embodiments described in the claims or specification of the disclosure may be implemented in the form of hardware, software, or a combination thereof.

When implemented in software, a computer-readable storage medium storing one or more programs (software modules) may be provided. The one or more programs stored in the computer-readable storage medium may be configured to be executable by one or more processors of an electronic device. The one or more programs may include instructions that cause the electronic device to execute the methods according to the embodiments described in the claims or specification of the disclosure.

Such a program (software module, software) may be stored in a random access memory, a nonvolatile memory such as a flash memory, a read only memory (ROM), an electrically erasable programmable read only memory (EEPROM), a magnetic disc storage device, a compact disc ROM (CD-ROM), a digital versatile disc (DVD), other types of optical storage devices, or a magnetic cassette. Or, such a program may be stored in a memory composed of a combination of some or all of them. In addition, a plurality of component memories may be included.

In addition, such a program may be stored in an attachable storage device that can be accessed through a communication network such as the Internet, an intranet, a local area network (LAN), a wide LAN (WLAN), or a storage area network (SAN), or through a communication network composed of a combination thereof. Such a storage device may access the device that carries out an embodiment of the disclosure through an external port. In addition, a separate storage device on a communication network may access the device that carries out an embodiment of the disclosure.

In the embodiments of the disclosure described above, the elements included in the disclosure are expressed in a singular or plural form according to the presented specific embodiment. However, the singular or plural expression is appropriately selected for ease of description according to the presented situation, and the disclosure is not limited by a single element or plural elements. Those elements described in a plural form may be configured as a single element, and those elements described in a singular form may be configured as plural elements.

Meanwhile, the embodiments of the disclosure disclosed in the present specification and drawings are only provided as specific examples to easily explain the technical details of the disclosure and to aid understanding of the disclosure, and are not intended to limit the scope of the disclosure. That is, it will be apparent to those of ordinary skill in the art that other modifications based on the technical idea of the disclosure can be carried out. In addition, some of the embodiments may be combined with each other if necessary for operation.

Meanwhile, in the drawing depicting a method of the disclosure, the order of description does not necessarily correspond to the order of execution, and steps or operations may be changed in their order or may be executed in parallel.

Alternatively, in the drawing depicting a method of the disclosure, only some elements may be included by omitting some other elements within the scope that does not impair the essence of the disclosure.

In addition, the method of the disclosure may be implemented by combining some or all of the content included in embodiments within the scope that does not impair the essence of the disclosure.

Various embodiments of the disclosure have been described above. The above description of the disclosure is for illustrative purposes, and embodiments of the disclosure are not limited to those disclosed. A person skilled in the art to which the disclosure pertains will understand that the disclosure can be readily modified into another specific form without changing its technical idea or essential features. The scope of the disclosure is indicated by the claims described below rather than the detailed description above, and all changes or modified forms derived from the meaning and scope of the claims and their equivalent concepts should be construed as being included in the scope of the disclosure.

1-15. (canceled)

16. A method performed by a user equipment (UE) in a wireless communication system, the method comprising:
receiving, from a base station, autonomous denial information associated with an in-device coexistence (IDC) for a cell group;
identifying a problem of the IDC; and
in case that the problem of the IDC is identified, determining to deny a transmission in an uplink (UL) slot for the cell group based on the autonomous denial information.

17. The method of claim 16, wherein the autonomous denial information includes first information indicating a maximum number of the UL slot for denying the transmission.

18. The method of claim 16, wherein the autonomous denial information includes second information indicating a validity period associated with the UL slot for denying the transmission.

19. The method of claim 16, wherein the autonomous denial information is configured per cell group.

20. The method of claim 16, further comprising:
transmitting, to the base station, an UE assistance information message including an affected carrier frequency list and an affected carrier frequency combination list.

21. A method performed by a base station in a wireless communication system, the method comprising:
generating, autonomous denial information associated with an in-device coexistence (IDC) for a cell group; and
transmitting, to a user equipment (UE), the autonomous denial information;
wherein the autonomous denial information is associated with denying a transmission of an uplink (UL) slot for the cell group based on an identification of the IDC.

22. The method of claim 21, wherein the autonomous denial information includes first information indicating a maximum number of the UL slot for denying the transmission.

23. The method of claim 21, wherein the autonomous denial information includes second information indicating a validity period associated with the UL slot for denying the transmission.

24. The method of claim 21, wherein the base station configures the autonomous denial information per cell group.

25. The method of claim 21, further comprising:
receiving, from the UE, an UE assistance information message including an affected carrier frequency list and an affected carrier frequency combination list.

26. A user equipment (UE) in a wireless communication system, the UE comprising:
a transceiver; and
a controller configured to:
receive, from a base station, autonomous denial information associated with an in-device coexistence (IDC) for a cell group,
identify a problem of the IDC, and
in case that the problem of the IDC is identified, determine to deny a transmission in an uplink (UL) slot for the cell group based on the autonomous denial information.

27. The UE of claim 26, wherein the autonomous denial information includes first information indicating a maximum number of the UL slot for denying the transmission.

28. The UE of claim 26, wherein the autonomous denial information includes second information indicating a validity period associated with the UL slot for denying the transmission.

29. The UE of claim 26, wherein the autonomous denial information is configured per cell group.

30. The UE of claim 26, wherein the controller is further configured to:
transmit, to the base station, an UE assistance information message including an affected carrier frequency list and an affected carrier frequency combination list.

31. A base station in a wireless communication system, the base station comprising:
a transceiver; and
a controller configured to:
generate, autonomous denial information associated with an in-device coexistence (IDC) for a cell group, and
transmit, to a user equipment (UE), the autonomous denial information;
wherein the autonomous denial information is associated with denying a transmission of an uplink (UL) slot for the cell group based on an identification of the IDC.

32. The base station of claim 31, wherein the autonomous denial information includes first information indicating a maximum number of the UL slot for denying the transmission.

33. The base station of claim 31, wherein the autonomous denial information includes second information indicating a validity period associated with the UL slot for denying the transmission.

34. The base station of claim 31, wherein the base station configures the autonomous denial information per cell group.

35. The base station of claim 31, wherein the controller is further configured to:
receive, from the UE, an UE assistance information message including an affected carrier frequency list and an affected carrier frequency combination list.
